(19) United States
(12) Patent Application Publication
(10) Pub. No.: US 2016/0138400 A1
(43) Pub. Date: May 19, 2016

(54) ALUMINUM ALLOYS HAVING IRON, SILICON, VANADIUM AND COPPER

(71) Applicant: ALCOA INC., Pittsburgh, PA (US)

(72) Inventors: Lynette M. Karabin, Ruffs Dale, PA (US); Cagatay Yanar, Pittsburgh, PA (US); David W. Heard, Pittsburgh, PA (US); Wei Wang, State College, PA (US)

(21) Appl. No.: 14/942,534

(22) Filed: Nov. 16, 2015

Related U.S. Application Data
(60) Provisional application No. 62/080,780, filed on Nov. 17, 2014.

(51) Int. Cl. F01D 5/12; C22C 21/00; F28F 21/08; C22F 1/057; C22F 1/04; F04D 29/28; C22C 21/14; B23K 15/00

(52) U.S. Cl. CPC F01D 5/12; C22C 21/14; C22C 21/00; B23K 15/0086; B23K 15/0093; C22F 1/057; C22F 1/04; F04D 29/284; F28F 21/084; B23K 2203/10

(57) ABSTRACT

New aluminum alloys having iron, vanadium, silicon and copper are disclosed. The new alloys may include from 3 to 12 wt. % Fe, from 0.1 to 3 wt. % V, from 0.1 to 3 wt. % Si, and from 1.0 to 6 wt. % Cu, the balance being aluminum and impurities. The new aluminum alloys may be produced via additive manufacturing techniques, which may facilitate rapid solidification of a molten pool of the aluminum alloy.

### CROSS-REFERENCE TO RELATED APPLICATION

This patent application claims benefit of priority of U.S. Provisional Patent Application No. 62/080,780, filed Nov. 17, 2014, entitled “ALUMINUM ALLOYS HAVING IRON, SILICON, VANADIUM AND COPPER”, which is incorporated herein by reference in its entirety.

### BACKGROUND

Aluminum alloys are useful in a variety of applications. However, many aluminum alloys tend to decrease in strength upon exposure to elevated temperatures.

### SUMMARY OF THE INVENTION

Broadly, the present disclosure relates to new aluminum alloy bodies having iron, silicon, vanadium and copper. The amount of iron (Fe), silicon (Si) and vanadium (V) contained within the aluminum alloy body may be sufficient to provide for at least 5 vol. % AlFeVSi dispersoids. The amount of copper (Cu) contained within the aluminum alloy body may be sufficient to realize at least 0.25 vol. % of Al₂Cu precipitates and/or dispersion-strengtheners (e.g., if copper combines with Fe, V or Si, either in a dispersed phase or in a cellular structure). The AlFeVSi dispersoids may facilitate strength retention in elevated temperature applications (e.g., for aerospace and/or automotive applications). Any Al₂Cu precipitates may facilitate precipitation hardening and any copper-containing dispersion-strengtheners may facilitate dispersion hardening, thereby increasing the strength of the aluminum alloy body. Furthermore, the Al₂Cu precipitates and/or copper-containing dispersoids may be resistant to coarsening at elevated temperatures, also further improving the elevated temperature properties of the aluminum alloy body. In this regard, the new aluminum alloy bodies generally comprise (and in some instances, consist essentially of) from 3 to 12 wt. % Fe, from 0.1 to 3 wt. % V, from 0.1 to 3 wt. % Si; and from 1.0 to 6 wt. % Cu, the balance being aluminum and impurities.

The amount of iron, silicon and vanadium within the aluminum alloy body may be varied relative to the desired amount of AlFeVSi dispersoids, but the amount of iron, silicon and vanadium contained within the aluminum alloy body may be sufficient to provide for at least 5 vol. % AlFeVSi dispersoids, and up to 35 vol. % AlFeVSi dispersoids. The amount of AlFeVSi dispersoids in the aluminum alloy body is determined by metallographically preparing a cross section through a final part, using a scanning electron microscope (SEM) with appropriate image analysis software to measure the area fraction of the AlFeVSi dispersed phase, and, if appropriate, supplemented by a transmission electron microscope (TEM) analysis of a foil of the final part with appropriate image analysis software. The AlFeVSi dispersoids generally have an average size of from about 40 nm to about 500 nm. It is preferred that the average size of the AlFeVSi dispersoids within the final product be towards the lower end of this range. In one embodiment, the AlFeVSi dispersoids have an average size of not greater than about 250 nm. In another embodiment, the AlFeVSi dispersoids have an average size of not greater than about 200 nm. In yet another embodiment, the AlFeVSi dispersoids have an average size of not greater than about 150 nm. In another embodiment, the AlFeVSi dispersoids have an average size of not greater than about 100 nm. In yet another embodiment, the AlFeVSi dispersoids have an average size of not greater than about 75 nm. In another embodiment, the AlFeVSi dispersoids have an average size of not greater than about 60 nm.

In one embodiment, the amount of iron, silicon and vanadium contained within the aluminum alloy body may be sufficient to provide for at least 10 vol. % AlFeVSi dispersoids. In another embodiment, the amount of iron, silicon and vanadium contained within the aluminum alloy body may be sufficient to provide for at least 15 vol. % AlFeVSi dispersoids. In yet another embodiment, the amount of iron, silicon and vanadium contained within the aluminum alloy body may be sufficient to provide for at least 20 vol. % AlFeVSi dispersoids. In another embodiment, the amount of iron, silicon and vanadium contained within the aluminum alloy body may be sufficient to provide for at least 25 vol. % AlFeVSi dispersoids. In yet another embodiment, the amount of iron, silicon and vanadium contained within the aluminum alloy body may be sufficient to provide for at least 30 vol. % AlFeVSi dispersoids. In one embodiment, the aluminum alloy body contains 25+/−3 vol. % AlFeVSi dispersoids. In some embodiments, at least some copper (e.g., from 1 to 5 wt. % of the dispersoids) is included in the AlFeVSi dispersoids, as measured by a microprobe analysis.

In one embodiment, a new aluminum alloy body comprises from 4 to 11 wt. % Fe. In another embodiment, a new aluminum alloy body comprises from 5 to 10 wt. % Fe. In yet another embodiment, a new aluminum alloy body comprises from 6 to 9.5 wt. % Fe. In another embodiment, a new aluminum alloy body comprises from 6.5 to 9.0 wt. % Fe. In another embodiment, a new aluminum alloy body includes about 8.5 wt. % Fe. Iron is generally the predominate alloying element of the aluminum alloy body, aside from aluminum.

In one embodiment, a new aluminum alloy body comprises from 0.25 to 3 wt. % V. In another embodiment, a new aluminum alloy body comprises from 0.5 to 3 wt. % V. In yet another embodiment, a new aluminum alloy body comprises from 0.75 to 2.75 wt. % V. In another embodiment, a new aluminum alloy body comprises from 1.0 to 2.50 wt. % V. In yet another embodiment, a new aluminum alloy body comprises from 1.0 to 2.25 wt. % V. In another embodiment, a new aluminum alloy body comprises from 1.0 to 2.0 wt. % V. In yet another embodiment, a new aluminum alloy body includes about 1.5 wt. % V.

In one embodiment, a new aluminum alloy body comprises from 0.25 to 3 wt. % Si. In another embodiment, a new aluminum alloy body comprises from 0.5 to 3 wt. % Si. In yet another embodiment, a new aluminum alloy body comprises from 0.75 to 2.75 wt. % Si. In another embodiment, a new aluminum alloy body comprises from 1.0 to 2.50 wt. % Si. In yet another embodiment, a new aluminum alloy body comprises from 1.25 to 2.50 wt. % Si. In another embodiment, a new aluminum alloy body comprises from 1.25 to 2.25 wt. % Si. In yet another embodiment, a new aluminum alloy body includes about 1.7 wt. % Si. In one embodiment, the amount of silicon exceeds the amount of vanadium in the aluminum alloy body.

The amount of copper within the aluminum alloy body may be varied relative to the desired amount of Al₂Cu precipitates and/or copper-containing dispersion-strengtheners. In one embodiment, a new aluminum alloy body comprises from 1.0 to 5.5 wt. % Cu. In another embodiment, a new aluminum alloy body comprises from 1.5 to 5.0 wt. % Cu. In yet another embodiment, a new aluminum alloy body comprises from 2.0 to 4.5 wt. % Cu. In another embodiment, a new aluminum alloy body comprises from 2.5 to 4.5 wt. % Cu. In yet another embodiment, a new aluminum alloy body comprises from 3.0 to 4.5 wt. % Cu. In another embodiment, a new aluminum alloy body comprises from 3.0 to 4.0 wt. % Cu. In another embodiment, a new aluminum alloy body includes about 3.5 wt. % Cu.

In one embodiment, the amount of copper contained within the aluminum alloy body may be sufficient to provide for at least 0.25 vol. % Al₂Cu precipitates, and up to 6.5 vol. % Al₂Cu precipitates. The Al₂Cu precipitates may be in the equilibrium (incoherent) state, sometimes referred to by those skilled in the art as the “theta (θ) phase”, or the Al₂Cu precipitates may be in the non-equilibrium (coherent) state, sometimes referred to those skilled in the art as the theta prime (θ′) phase. In the absence of silver, some of the Al₂Cu precipitates may be located on the {100} planes (FCC) of the aluminum alloy grains. When silver is used in the alloy, as described below at least, some of the Al₂Cu precipitates may also or alternatively be located on the {111} planes (FCC) of the aluminum alloy grains. The amount of Al₂Cu precipitates in the aluminum alloy body is determined via SEM and/or TEM, as described above. In one embodiment, the amount of copper contained within the aluminum alloy body may be sufficient to provide for at least 0.50 vol. % Al₂Cu precipitates, and up to 6.5 vol. % Al₂Cu precipitates. In another embodiment, the amount of copper contained within the aluminum alloy body may be sufficient to provide for at least 1.0 vol. % Al₂Cu precipitates, and up to 6.5 vol. % Al₂Cu precipitates. In yet another embodiment, the amount of copper contained within the aluminum alloy body may be sufficient to provide for at least 1.5 vol. % Al₂Cu precipitates, and up to 6.5 vol. % Al₂Cu precipitates. In another embodiment, the amount of copper contained within the aluminum alloy body may be sufficient to provide for at least 2.0 vol. % Al₂Cu precipitates, and up to 6.5 vol. % Al₂Cu precipitates. In yet another embodiment, the amount of copper contained within the aluminum alloy body may be sufficient to provide for at least 2.5 vol. % Al₂Cu precipitates, and up to 6.5 vol. % Al₂Cu precipitates. In another embodiment, the amount of copper contained within the aluminum alloy body may be sufficient to provide for at least 3.0 vol. % Al₂Cu precipitates, and up to 6.5 vol. % Al₂Cu precipitates. In yet another embodiment, the amount of copper contained within the aluminum alloy body may be sufficient to provide for at least 3.5 vol. % Al₂Cu precipitates, and up to 6.5 vol. % Al₂Cu precipitates. In another embodiment, the amount of copper contained within the aluminum alloy body may be sufficient to provide for at least 4.0 vol. % Al₂Cu precipitates, and up to 6.5 vol. % Al₂Cu precipitates. In yet another embodiment, the amount of copper contained within the aluminum alloy body may be sufficient to provide for at least 4.5 vol. % Al₂Cu precipitates, and up to 6.5 vol. % Al₂Cu precipitates. In another embodiment, the amount of copper contained within the aluminum alloy body may be sufficient to provide for at least 5.0 vol. % Al₂Cu precipitates, and up to 6.5 vol. % Al₂Cu precipitates. In yet another embodiment, the amount of copper contained within the aluminum alloy body may be sufficient to provide for at least 5.5 vol. % Al₂Cu precipitates, and up to 6.5 vol. % Al₂Cu precipitates.

In another embodiment, the aluminum alloy body may comprise a cellular structure within an aluminum matrix, and the copper (Cu) may partially make-up this cellular structure. For instance, the copper may combine with iron and/or silicon to form a cellular structure within the aluminum matrix. The cellular structure may include, for instance, 1-10 wt. % Cu.

Table 1, below, table lists various inventive alloys compositions (all values in weight percent).

TABLE 1
Inventive Alloy Compositions

| | Fe | | | | |
|---|---|---|---|---|---|
| | (Fe > Cu, V, | | | | |
| Alloy | Si) | V | Si | Cu | Balance |
| E1 | 3-12 | 0.1-3 | 0.1-3 | 1.0-6 | Al. and impurities |
| E2 | 4-11 | 0.25-3 | 0.25-3 | 1.0-5.5 | Al. and impurities |
| E3 | 5-10 | 0.5-3 | 0.5-3 | 1.5-5.0 | Al. and impurities |
| E4 | 6-9.5 | 0.75-2.75 | 0.75-2.75 | 2.0-4.5 | Al. and impurities |
| E5 | 6.5-9.5 | 1.0-2.5 | 1.0-2.5 | 2.5-4.5 | Al. and impurities |
| | | | Si ≧ V | | |
| E6 | 6.5-9.0 | 1.0-2.25 | 1.25-2.5 | 3.0-4.5 | Al. and impurities |
| | | | Si ≧ V | | |
| E7 | 6.5-9.0 | 1.0-2.0 | 1.25-2.25 | 3.0-4.0 | Al. and impurities |
| | | | Si > V | | |
| E8 | 8.5 +/− 0.75 | 1.5 +/− 0.25 | 1.7 +/− 0.25 | 3.5 +/− 0.35 | Al. and impurities |
| | | | Si > V | | |

Regarding impurities, when the aluminum alloy body is silver-free (<0.10 wt. % Ag), the aluminum alloy body is generally sufficiently free of magnesium (Mg) to restrict/avoid formation of S phase (Al₂CuMg) precipitates, which are generally detrimental in elevated temperature applications. The presence of magnesium may also decrease the amount of Al₂Cu precipitates within the aluminum alloy body. In this regard, when the aluminum alloy body is silver-free, the aluminum alloy body generally contains not greater than 0.30 wt. % Mg. In one embodiment, the aluminum alloy body is silver-free and contains not greater than 0.20 wt. % Mg. In another embodiment, the aluminum alloy body is silver-free and contains not greater than 0.15 wt. % Mg. In yet another embodiment, the aluminum alloy body is silver-free and contains not greater than 0.10 wt. % Mg.

Silver may optionally be included in the aluminum alloy body. When silver is included, the aluminum alloy body should also include an amount of magnesium that facilitates creating Al₂Cu precipitates on one or more {111} planes of the aluminum alloy grains. In one embodiment, the aluminum alloy body contains a sufficient amount of silver and magnesium such that at least some Al₂Cu precipitates are created on one or more {111} planes of the aluminum alloy grains, but the amount of silver and magnesium is restricted such that undesirable phases, such as the S phase, are avoided or restricted. In this regard, the aluminum alloy body may include 0.10-1.0 wt. % Ag and 0.10-1.0 wt. % Mg, with the relative amounts being limited such that undesirable phases, such as the S phase, are avoided or restricted.

The aluminum alloy body is generally sufficiently free of zinc (Zn) to restrict/avoid formation of eta (η) phase (MgZn₂) precipitates, which are generally detrimental in elevated temperature applications. In this regard, the aluminum alloy body generally contains not greater than 0.5 wt. % Zn. In one embodiment, the aluminum alloy body contains not greater than 0.35 wt. % Zn. In another embodiment, the aluminum alloy body contains not greater than 0.25 wt. % Zn. In yet another embodiment, the aluminum alloy body contains not greater than 0.15 wt. % Zn. In another embodiment, the aluminum alloy body contains not greater than 0.10 wt. % Zn. In yet another embodiment, the aluminum alloy body contains not greater than 0.05 wt. % Zn. In another embodiment, the aluminum alloy body contains not greater than 0.01 wt. % Zn. In yet another embodiment, the aluminum alloy body contains less than 0.01 wt. % Zn.

The new aluminum alloy bodies are generally produced via a method that facilitates selective heating of powders comprising the Al, Fe, V, Si, and Cu to temperatures above the liquidus temperature of the particular aluminum alloy body to be formed, thereby forming a molten pool having the Al, Fe, V, Si, and Cu, followed by rapid solidification of the molten pool. The rapid solidification may facilitate maintaining at least some of the copper in solid solution.

In one embodiment, the new aluminum alloy bodies are produced via additive manufacturing techniques, such as Selective Laser Sintering (SLS), Selective Laser Melting (SLM), and Electron Beam Melting (EBM), among others. Additive manufacturing techniques facilitate the selective heating of powders comprising the Al, Fe, V, Si, and Cu to temperatures above the liquidus temperature of the particular aluminum alloy, thereby forming a molten pool having the Al, Fe, V, Si, and Cu, followed by rapid solidification of the molten pool.

In one embodiment, a method comprises (a) dispersing a powder comprising the Al, Fe, V, Si, and Cu in a bed, (b) selectively heating a portion of the powder (e.g., via a laser) to a temperature above the liquidus temperature of the particular aluminum alloy body to be formed, (c) forming a molten pool having the Al, Fe, V, Si, and Cu, and (d) cooling the molten pool at a cooling rate of at least 1000° C. per second. In one embodiment, the cooling rate is at least 10,000° C. per second. In another embodiment, the cooling rate is at least 100,000° C. per second. In another embodiment, the cooling rate is at least 1,000,000° C. per second. Steps (a)-(d) may be repeated as necessary until the aluminum alloy body is completed, i.e., until the final additively manufactured aluminum alloy body is formed/completed. The final aluminum alloy body may have at least 5 vol. % AlFeVSi dispersoids, and up to 35 vol. % AlFeVSi dispersoids. The final aluminum alloy body may be of a complex geometry, or may be of a simple geometry (e.g., in the form of a sheet or plate).

The particles for the powder to be used in the additive manufacturing may be obtained or formed via any suitable method. In one embodiment, discrete and different particles for each of Al, Fe, V, Si, and Cu are used (i.e., particles of Fe, particles of V, particles of Si, and particles of Cu are obtained and provided to the bed in the appropriate amounts). In another embodiment, generally homogenous particles are used, where the particles generally comprise all of Al, Fe, V, Si, and Cu. In this embodiment, the generally homogenous particles may be produced via atomization of a molten metal comprising the desired amounts of Al, Fe, V, Si, and Cu.

In one approach, electron beam (EB) techniques are utilized to produce the aluminum alloy body. Electron beam techniques may facilitate production of larger parts than readily produced via laser additive manufacturing techniques. For instance, and with reference now to FIG. 1, in one embodiment, a method comprises feeding a small diameter wire (25) (e.g., a tube ≦2.54 mm in diameter) to the wire feeder portion of an electron beam gun (50). The wire (25) may be of the aluminum alloy compositions, described above, provided it is a drawable composition (e.g., when produced per the process conditions of U.S. Pat. No. 5,286,577). The electron beam (75) heats the wire or tube, as the case may be, above the liquidus point of the aluminum alloy part to be formed, followed by rapid solidification of the molten pool to form the deposited aluminum alloy material (100)(e.g., an aluminum alloy body having at least 5 vol. % AlFeVSi dispersoids, and up to 35 vol. % AlFeVSi dispersoids). In one embodiment, the wire (25) is a powder cored wire (200), where a tube may comprise particles of the aluminum alloy compositions, described above, within the tube, while the shell of the tube may comprise aluminum or a high purity aluminum alloy (e.g., a suitable 1xxx aluminum alloy).

After completion of the rapid solidification (cooling) step, the final aluminum alloy body may optionally be naturally aged, optionally cold worked, and then artificially aged. The natural aging may occur for a period of time sufficient to stabilize the properties of the aluminum alloy body (e.g., for a few days). The optional cold working step may include deforming the aluminum alloy body from 1-10% (e.g., by compression or stretching). The aluminum alloy body may be artificially aged (e.g., to form Al₂Cu precipitates such that the aluminum alloy body includes from 0.25 vol. % to 6.5 vol. % of the Al₂Cu precipitates and/or copper-containing dispersoids). The artificial aging may occur for a time and at a temperature sufficient to form the desired volume of Al₂Cu precipitates and/or copper-containing dispersoids (e.g., artificial aging at a temperature of from 125° C. to 200° C. for times from 2 to 48 hours, or longer, as appropriate). The artificial aging may be a single step, or a multi-step artificial aging practice. In one embodiment, higher temperatures may be used, for example, to potentially modify (e.g., to spheroidize) (if appropriate) at least some of the AlFeVSi dispersoids (e.g., potentially as high as 300° C., provided the higher temperatures do no excessively coarsen the Al₂Cu particles and/or copper-containing dispersoids). In some instance, the final aluminum alloy body may be annealed followed by slow cooling. Annealing may relax the microstructure. The annealing may occur, for instance, prior to cold working, or before or after artificial aging. In some instances, the final aluminum alloy body may be solution heat treated and then quenched, after which any natural aging, optional cold working, and artificially aging may be completed. The solution heat treating and quenching may facilitate, for instance, an increased volume fraction of Al₂Cu precipitates by placing at least some of the copper in solid solution with the aluminum.

While the inventive aluminum alloys have generally been described herein as having iron and vanadium as alloying elements, it is believed that various substitutes can be used for the iron and vanadium. For example, it is believed that cobalt (Co), manganese (Mn), and nickel (Ni) may be wholly or partially substituted for the iron, and in any combination, so long as dispersoids similar to the AlFeVSi dispersoids are formed. Chromium (Cr), molybdenum (Mo) and niobium (Nb) may partially substitute for the iron (e.g., potentially up to about 5 wt. %), and in any combination, so long as dispersoids similar to AlFeVSi dispersoids are formed. Regarding vanadium, it is believed that any of hafnium (Hf), zirconium (Zr), scandium (Sc), chromium (Cr), or titanium (Ti) may be wholly or partially substituted for the vanadium, and in any combination, so long as dispersoids similar to AlFeVSi dispersoids are formed.

The new aluminum alloy bodies may be utilized in a variety of applications, such as for elevated temperature applications for aerospace or automotive vehicles, among other applications. In one embodiment, a new aluminum alloy body is utilized as an engine component in an aerospace vehicle (e.g., in the form of a blade, such as a compressor blade incorporated into the engine). In another embodiment, the new aluminum alloy body is used as a heat exchanger for the engine of the aerospace vehicle. The aerospace vehicle including the engine component/heat exchanger may subsequently be operated. In one embodiment, a new aluminum alloy body is an automotive engine component. The automotive vehicle including the engine component may subsequently be operated. For instance, a new aluminum alloy body may be used as a turbo charger component (e.g., a compressor wheel of a turbo charger, where elevated temperatures may be realized due to recycling engine exhaust back through the turbo charger), and the automotive vehicle include the turbo charger component may be operated. In another embodiment, an aluminum alloy body may be used as a blade in a land based (stationary) turbine for electrical power generation, and the land based turbine included the aluminum alloy body may be operated to facilitate electrical power generation.

### BRIEF DESCRIPTION OF THE DRAWINGS

FIG. 1 is a schematic, perspective view of an embodiment of an electron beam apparatus for use in producing additively manufactured aluminum alloy bodies.

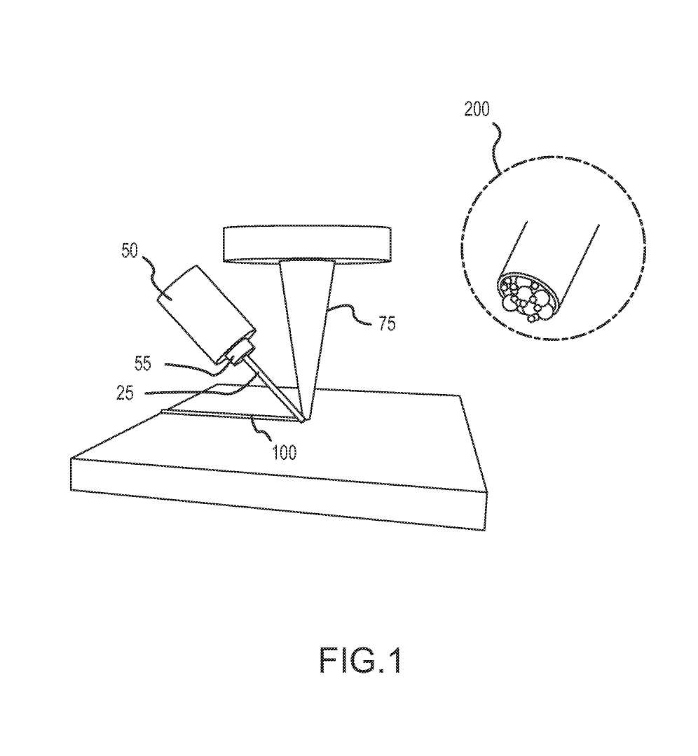

FIGS. 2(A) and 2(B) are scanning electron images of the Al—Fe—V—Si—Cu alloy in the as-built condition; FIG. 2(A) shows a fine distribution of Al—Fe—V—Si dispersoids; FIG. 2(B) shows a cellular structure comprising Fe and Cu.

### DETAILED DESCRIPTION

### Example 1

An Al—Fe—V—Si—Cu ingot was used as feedstock and was subject to an inert gas atomization process to produce powder. The powder was then screened and blended for use in producing additively manufactured products. The products were additively manufactured via powder bed fusion (PBF) using an EOS M280 machine. Chemical analysis of the powder and the as-built components (final products) was conducted via inductively coupled plasma (ICP), the results of which are shown in Table 2, below (all values in weight percent).

TABLE 2
Compositions

| Item | Fe | V | Si | Cu | Balance* |
|---|---|---|---|---|---|
| Starting powder | 8.14 | 1.48 | 1.66 | 2.10 | Al and imp. |
| As-Built | 8.08 +/0.13 | 1.46 +/− 0.02 | 1.65 +/− 0.02 | 2.09 +/− 0.03 | Al and imp. |
| Components** | | | | | |

*The impurities were less than 0.03 wt. % each and less than 0.10 wt. % in total.
**Average composition of 24 as-built components with standard deviation shown as +/−.

The density of the as-built components was determined using an Archimedes density analysis procedure in accordance with NIST standards. The Archimedes density analysis revealed that densities in excess of 99% of the theoretical density were obtained within the as-built components.

The microstructure of the as-built components was analyzed via optical metallography (OM), scanning electron microscopy (SEM), electron probe microanalysis (EPMA), and transmission electron microscopy (TEM). OM was performed on specimens prepared by mounting sections of the as-built specimens in Bakelite and then grinding and polishing using a combination of polishing media. The OM analysis revealed less than 1% porosity to be present within the specimens, thereby confirming the Archimedes density results.

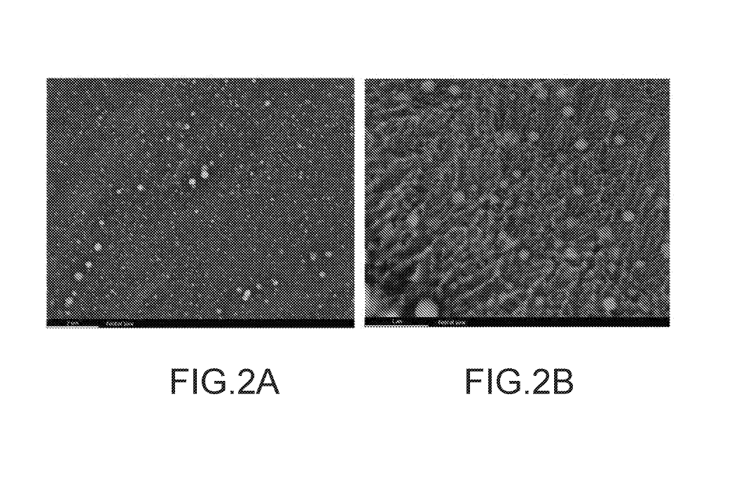

SEM imaging was performed using the same specimens prepared for OM analysis and revealed the presence of both a globular dispersoid phase (i.e., fine particles, unable to be re-dissolved back into solid solution) and a fine cellular phase, representative images of which are shown in FIGS. 2(A) and 2(B). Image analysis of one of these specimens was performed to determine the size distribution and volume fraction of the dispersoid phase. A single image with an area of >100 μm² was used for the image analysis. The resulting analysis revealed that the dispersoids ranged in diameter from about 30 to 400 nm, with an average of about 75 nm. It was also determined that the volume fraction of the dispersoids was about 6.7%. EPMA revealed that the fine dispersoids were enriched in iron (Fe) and vanadium (V), and are believed to be of the Al₁₂(Fe,V)₃Si type.

Transmission electron microscopy (TEM) was employed to determine the composition of the cell walls. Electron transparent TEM foils were prepared from both as-built and thermally treated specimens (treated at about 375° F. for about 18 hours) by mechanically thinning the specimens prior to applying a final electrojet polishing step using a solution consisting of nitric acid (HNO₃) and methanol with an applied voltage of 20-30 volts. The TEM analysis revealed the cell walls to be enriched in copper (Cu) and iron (Fe).

While various embodiments of the present disclosure have been described in detail, it is apparent that modifications and adaptations of those embodiments will occur to those skilled in the art. However, it is to be expressly understood that such modifications and adaptations are within the spirit and scope of the present disclosure.

What is claimed is:

1. An aluminum alloy consisting essentially of:
from 3 to 12 wt. % Fe;
from 0.1 to 3 wt. % V;
from 0.1 to 3 wt. % Si; and
from 1.0 to 6 wt. % Cu;
the balance being aluminum and impurities.

2. An aluminum alloy body made from the aluminum alloy of claim 1.

3. The aluminum alloy body of claim 2, wherein the aluminum alloy body is in the form of an engine component for an aerospace vehicle.

4. The aluminum alloy body of claim 2, comprising from 5 to 35 vol. % AlFeVSi dispersoids.

5. The aluminum alloy body of claim 4, wherein the AlFeVSi dispersoids comprise at least some copper.

6. The aluminum alloy body of claim 2, comprising a cellular structure comprising iron and copper.

7. A method of making an aluminum alloy body, comprising:
(a) dispersing a powder comprising in a bed, wherein the powder consists essentially of:
from 3 to 12 wt. % Fe;
from 0.1 to 3 wt. % V;
from 0.1 to 3 wt. % Si; and
from 1.0 to 6 wt. % Cu,
the balance being aluminum (Al) and impurities;
(b) selectively heating a portion of the powder to a temperature above the liquidus temperature of the particular aluminum alloy body to be formed;
(c) forming a molten pool having the Fe, V, Si, Cu, and Al;
(d) cooling the molten pool at a cooling rate of at least 1000° C. per second; and
(e) repeating steps (a)-(d) to form an additively manufactured aluminum alloy body.

8. The method of claim 7, comprising:
completing the additively manufactured aluminum alloy body, thereby realizing a final aluminum alloy product;
naturally aging the final aluminum alloy product; and
after the natural aging, artificially aging the final aluminum alloy product.

9. The method of claim 8, comprising:
after the naturally aging step, deforming the final aluminum alloy product by from 1 to 10%.

10. The method of claim 8, wherein the artificial aging comprises:
heating the final aluminum alloy product at a temperature of from 125° C. to 300° C. and for a period of from 2 to 48 hours.

11. The method of claim 10, wherein the final aluminum alloy product is in the form of an engine component for an aerospace or automotive vehicle, wherein the method comprises:
incorporating the engine component into the aerospace or automotive vehicle.

12. The method of claim 11, comprising:
operating the aerospace or automotive vehicle.

13. The method of claim 11, wherein the final aluminum alloy product is a compressor wheel for a turbo charger.

14. The method of claim 11, wherein the final aluminum alloy product is a blade for a turbine.

15. The method of claim 11, wherein the final aluminum alloy product is a heat exchanger.
